(19) United States
(12) Patent Application Publication
(10) Pub. No.: US 2005/0114259 A1
(43) Pub. Date: May 26, 2005

(54) Mortgage option method

(76) Inventor: Joe W. Almeida, Coconut Creek, FL (US)

Correspondence Address: LITMAN LAW OFFICES, LTD., P.O. BOX 15035 CRYSTAL CITY STATION, ARLINGTON, VA, 22215, US

(21) Appl. No.: 10/717,454

(22) Filed: Nov. 21, 2003

(51) Int. Cl. G06F 17/60

(52) U.S. Cl. 705/38

(57) ABSTRACT

The mortgage option method is a way that applicants wishing to take advantage of low mortgage interest rates, but who, for whatever reason, are unable or unwilling to initiate the application process at the present time, can obtain a right to the low mortgage rate at some time in the future when mortgage rates have increased. Designed for either the residential or commercial real estate market, method allows customers to lock-in a mortgage at the then current rate for up to four years by paying a nonrefundable up-front premium. The mortgage option may be exercised at any time during the option term, at a rate lower than the prevailing rates.

### BACKGROUND OF THE INVENTION

1. Field of the Invention

The present invention relates to a new concept in residential mortgages or other investment type mortgages, and particularly to a method for selling options to lock in low mortgage interest rates.

2. DESCRIPTION OF THE RELATED ART

Home ownership in the United States is built on the basic home mortgage, whether it is fifteen years, thirty years, or some other term of repayment. Normally, and most conventionally, home mortgages and other such loans are amortized using a formula which provides that payments over the term of the loan are allocated to interest first, and then to principal. In the later years of repayment, a significant portion of the monthly loan payment, serves to reduce the principal due on the loan.

In order to compete more efficiently with other mortgage companies in the mortgage market, banks and other lenders have become very creative in structuring loans that appeal to more segments of the population, in periods of both rising and falling interest rates.

U.S. Patent Application No. 2002/0103750, published in August 2002, discloses a mortgage guaranty insurance policy having periodically adjusted premiums, the determination of the premiums being partially based on loan seasoning; and a claim settlement option chosen from the following: immediate lump-sum settlement, principal and interest payments being maintained for a fixed period prior to loan payoff, principal and interest payments being maintained until loan payoff is demanded by the insured, or principal and interest payments until the loan is paid off by the insurer.

U.S. Patent Application No. 2002/0059137, published in May 2002, discloses a system and method for reducing the mortgage interest rate and mortgage guaranty insurance premium associated with a mortgage loan by financing discount points into the mortgage loan at origination. In addition, the mortgage guaranty insurance premium is determined based on the original loan-to-value (LTV) percent, independent of the amount of discount points financed into the original loan.

U.S. Patent Application No. 2002/0046158, published in April 2002, discloses a computer-based method and system for controlling the mortgage rate charged to a mortgagee as a prevailing mortgage rate drops. Using an Automatic Rate Cut (A.R.C.) mortgage, a customer's interest rate may be reduced without going through a traditional refinance process. The A.R.C. Loan offers a model of financing either purchasing or refinancing property. Once the customer has been in the program for a specified period since settlement date, the interest rate can be modified down provided that interest rates have declined since the customer entered the A.R.C. Loan. Secondary conditions can also be used to determine if the mortgage qualifies for a rate reduction.

U.S. Patent Application No. 2002/0019805, published for Andrew Kalotay in February 2002, discloses a method for structuring a mortgage having an associated current interest rate based upon a time-varying market interest rate, whereby as the market interest rate declines with time, the current interest rate for the mortgage declines. When the market interest rate increases with time, the current interest rate remains unchanged. The method includes the steps of: calculating the current interest rate for the mortgage at a first time dependent upon the market interest rate at the first time; and secondly, calculating a reset interest rate for the mortgage at a second time dependent upon the market interest rate at the second time. If the reset rate is less than the current rate, the current rate is reset or updated to the reset rate and the mortgage is operated using the reset current interest rate. If the reset rate is equal to or greater than the current rate, the mortgage is operated using the current interest rate.

U.S. Patent Application No. 2001/0013017, published for Jay Berger in August 2001, discloses a principal priority reduction mortgage which provides both a method to reduce interest paid at a given interest rate and to increase a homeowner's equity rapidly in an otherwise conventional loan scenario. Loan payments are applied to principal due first, while interest accrues and is paid only after the full reduction of the principal.

None of the above inventions and patents, taken either singly or in combination, is seen to describe the instant invention as claimed. Thus a mortgage option method solving the aforementioned problems is desired.

### SUMMARY OF THE INVENTION

The present invention is a mortgage option method for locking in a currently low mortgage interest rate for a predetermined period by payment of an option premium. The option premium is determined by the length of the option period and the loan amount.

From time to time, mortgage rates may drop to very low levels, but many people who would like to take advantage of the low rates are unable or unwilling to refinance or acquire new property while the rates are low, for various reasons.

Interest rates may start to increase, in which case those who have not locked in at the low rates will pay more for their mortgage when they do decide to either refinance or buy. The present method for selling mortgage options offers customers the opportunity to lock-in a mortgage at low rate for an extended period of time selected by the customer by paying a premium determined by the length of the option. At any time within the option period, the customer may exercise their option and proceed with the loan application. Failure to exercise the option within the option period will result in forfeit of the low interest mortgage rate, as well as the premium paid to the lender offering the mortgage option.

The premium is determined by the lending institution and is based upon their determination of current market conditions and where they think rates will be during the various option periods. Where an analysis of conditions indicates that interest rates will climb radically, the premium will be higher than if the lending institution perceives a more stable rate environment. Because rate uncertainty increases the farther out in time the prediction is projected, the option price or rate will be higher for longer option periods.

In order to protect the lending institution against a precipitous rise in rates over a short term, the plan may be modified to allow the rate to increase along with the market rate. However, the maximum yearly increase is capped at one percentage point per year.

Accordingly, it is a principal object of the invention to provide a mortgage option that will allow homebuyers and those wishing to refinance their homes to lock in at a low interest rate for a preset time by payment of an option premium.

It is another object of the invention to provide a method of marketing options for low mortgage interest rates that will provide mortgage lenders with a larger market of home mortgage applicants.

It is a further object of the invention to provide a mortgage option method in which mortgage lenders extending an option for low mortgage interest rates are paid a nonrefundable option premium.

Still another object of the invention is to provide a mortgage option method which provides mortgage lenders with an additional source of revenue during periods of stable or decreasing mortgage interest rates.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### DETAILED DESCRIPTION OF THE PREFERRED EMBODIMENTS

The present invention is a method for marketing options for mortgages at low rates of interest for applicants wishing to take advantage of current low mortgage interest rates, but for whatever reason, are unable or unwilling to process the application at the present time. Designed for either the residential or commercial real estate market, the method of the present invention would allow customers to lock-in at the current rate for up to four years by paying a nonrefundable, up-front premium, which secures to them an option to obtain a mortgage loan at the desired low rate of interest if the option is exercised during the term of the option. The premium is determined by the lending institution and is based upon a determination of current market conditions and where the lender thinks rates will be during the various terms of the option. In a market which is highly competitive, the present invention addresses a new market segment consisting of future loan applicants and attempts not only to lock-in these future customers to their institution, but also to create additional revenue from the premiums received.

Designed primarily for stable markets, the concept of the present invention is that the lending institution is willing to guarantee a current low rate against the uncertainty of the future based upon the up-front payment of an option payment. In one scenario, the option payment will cover small increases in the lending rate, and in a second scenario, the applicant will forfeit the low interest loan and the premium by not exercising the option within the option term. The premium is not refundable, and is not credited towards principal or interest of any mortgage subsequently issued pursuant to exercise of the option. Where conditions indicate increasing interest rates, the premium will be higher than if the lending institution perceives a more stable rate environment. Furthermore, because rate uncertainty increases the farther out in time the prediction is projected, the option price or rate is higher for longer option terms and is set as a percentage of the anticipated load amount, being based upon an analysis of current and future market indicators. Table 1 shows a representative pricing model based upon different option terms. The Option Term Years and the Program Rate are flexible and are determined by the lending institute based upon their particular preferences.

TABLE 1

| Option Term | Loan Amount | Program Rate | Premium |
|---|---|---|---|
| Years | $ | % | $ |
| 0-1 Year | 180,000.00 | 1.5% | 2,700.00 |
| 0-2 Years | 180,000.00 | 2.5% | 4,500.00 |
| 0-3 Years | 180,000.00 | 4.0% | 7,200.00 |
| 0-4 Years | 180,000.00 | 5.0% | 9,000.00 |

As an example, when the 15-year conventional fixed rate mortgage is 6.5%, a customer wishing to postpone borrowing $180,000 for up to one year would, by paying a premium of $2,700 dollars, be able to lock-in a mortgage at 6.5% if exercised within the one-year period starting the day of premium payment.

Should the customer require funds in excess of the contracted option, the customer may secure a second mortgage at the prevailing rates. No refunds are made if the actual loan amount is less than the contracted mortgage option.

In order to protect the lending institution against a precipitous rise in rates over a short term, the method may be modified to allow the rate to increase along with the market rate. However, the maximum yearly increase is capped at one percentage point per year.

Of course, the option may be conditioned upon customary conditions, such as that the option holder is credit worthy for the principal amount financed at the time the option is exercised, etc.

The present invention is not limited to residential and commercial mortgage loans. A similar mechanism may be applied to equity loans as well as personal loans.

The method for marketing mortgage options for low interest mortgage rates of the present invention generally includes the following steps: offering options for mortgages at a fixed low interest rate for a premium dependent upon a desired principal amount and a desired option term; receiving a mortgage option application from a customer for a customer selected principal amount and a customer selected option term; determining the customer premium for the customer selected principal amount and the customer selected option term; extending an option to the customer for the customer selected principal amount and the customer selected option term for the customer premium; receiving payment of the customer premium; and extending a mortgage at the fixed low interest rate when the customer exercises the option within the customer option term.

It is to be understood that the present invention is not limited to the embodiment described above, but encompasses any and all embodiments within the scope of the following claims.

1. A method for marketing a low interest rate mortgage, comprising the steps of:
offering options for mortgages at a fixed low interest rate for a premium dependent upon a desired principal amount and a desired option term;
receiving a mortgage option application from a customer for a customer selected principal amount and a customer selected option term;
determining the customer premium for the customer selected principal amount and the customer selected option term;
extending an option to the customer for the customer selected principal amount and the customer selected option term for the customer premium;
receiving payment of the customer premium; and
extending a mortgage at the fixed low interest rate when the customer exercises the option within the customer option term.

2. The method for marketing according to claim 1, further comprising the step of pre-qualifying the customer before the customer selected option term begins.

3. The method for marketing according to claim 1, further comprising the step of terminating said option when the customer fails to exercise the option before the customer selected option term ends.

4. The method for marketing according to claim 1, wherein said option is for a residential property.

5. The method for marketing according to claim 1, wherein said option is for a commercial property.

6. The method for marketing according to claim 1, wherein said step of determining the customer premium further comprises the step of setting a premium based upon a percentage of the customer desired principal amount.

7. The method for marketing according to claim 1, wherein said offering step further comprises the step of publishing a table of the premiums for the fixed low interest rate, the desired principal amounts and the desired option terms.
